(19) United States
(12) Patent Application Publication
(10) Pub. No.: US 2005/0247791 A1
(43) Pub. Date: Nov. 10, 2005

(54) Mobile information terminal apparatus

(75) Inventors: Yasuhiro Sado, Saitama (JP); Yoshifumi Oohira, Saitama (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/005,243

(22) Filed: Dec. 7, 2004

(30) Foreign Application Priority Data
Dec. 26, 2003 (JP) 2003-435771

(51) Int. Cl. G06K 7/10

(52) U.S. Cl. 235/472.01

(57) ABSTRACT

A mobile information terminal apparatus includes a photoelectrically converting portion having light receiving elements with a scanner function on an LCD portion and an exchangeable non-volatile memory as a recording medium. The size and weight of the entire apparatus are reduced by arranging the photoelectrically converting portion to the LCD portion. The exchangeable non-volatile memory is used as the recording medium and therefore the operation is simple by replacing the non-volatile memory even when the storage capacity is insufficient.

### CROSS-REFERENCE TO RELATED APPLICATIONS

This application based upon and claims the priority from the prior Japanese Patent Application No. 2003-435771, filed on Dec. 26, 2004; the entire contents of which are incorporated herein by reference.

### BACKGROUND OF THE INVENTION

1. Field of the Invention

The present invention relates to a mobile information terminal apparatus having a function for displaying information and a function for capturing image information.

2. Description of the Related Art

A mobile information terminal apparatus such as a PDA (personal digital assistance) is widely spread in place of a business notebook and the like. In attendance to a meeting or the like, the mobile information terminal apparatus is carried without any paper media such as a notebook, the contents of meeting are directly inputted and stored, as data, in the mobile information terminal apparatus, and the schedule is inputted to the mobile information terminal apparatus for managing the schedule.

In the meeting, a person customarily exchanges his business card with a partner he has first met. It is much more convenient if the mobile information terminal apparatus has a function for recording data described on the business card.

For example, Japanese Unexamined Patent Application Publication No. 4-372064 discloses a mobile information terminal apparatus having an LCD (liquid crystal display) panel for displaying data stored in a memory and a scanner for business card, wherein the scanner for business card reads and stores a business card as image information, the information is read if necessary and is displayed on the LCD panel.

That is, the scanner for business card disclosed in Japanese Unexamined Patent Application Publication No. 4-372064 as the conventional art comprises: a light source for illuminating the business card; a photoelectrically converting portion for receiving reflecting light from the business card and converting the light into an electric signal; and an image data processing portion for capturing the business card information which is photoelectrically converted as image data. The apparatus main body has a memory for business card which stores the image data of the business card read by the scanner for business card. A CPU as business card information search means has a function for searching for image data of the business card which is stored in the memory for business card and a function for displaying the image data on the LCD panel.

However, the above-mentioned conventional mobile information terminal apparatus has the scanner for business card independently of the .LCD display device and therefore has such a problem that the entire apparatus increases in scale and the mobility deteriorates.

Further, when the memory for business card runs out of free capacity because of the built-in structure of the memory for business card, the existing image data is deleted and the free capacity needs to be ensured and the operation is not preferable because the data must be stored while the attention is always paid to the free capacity.

### SUMMARY OF THE INVENTION

Accordingly, it is an object of the present invention to provide a mobile information terminal apparatus, in which the increase in size of the entire apparatus is prevented and the preferable mobility is obtained even if the display panel and the scanner are provided and in addition the simple operation is possible in the case in which the apparatus runs out of storage capacity without deleting the existing data and thus has user-friendliness.

According to the present invention, there is provided a mobile information terminal apparatus having display means for displaying information, scanning means for capturing image information, and a recording medium for recording the information, wherein the scanning means is incorporated in the display means.

With the above-mentioned structure, the scanning means is incorporated in the display means, thereby realizing the compact size and the light weight of the entire apparatus. The scanning means comprises a plurality of light receiving elements arranged like dots to the display means and therefore the display portion is thinner. Further, the recording medium may be an exchangeable non-volatile memory. The reliability against the attack and oscillation is improved by using the exchangeable non-volatile memory as the recording medium. Furthermore, the recording medium may be an exchangeable compact hard disk. A larger memory capacity can be ensured by using the exchangeable compact hard disk as the recording medium. In addition, the arrangement of a touch panel onto the display means does not need any operating portion on the apparatus main body side and thus the size in display portion is relatively large or the entire apparatus decreases in size.

The above and other objects, features and advantages of the invention will become more clearly understood from the following description referring to the accompanying drawings.

### BRIEF DESCRIPTION OF THE DRAWINGS

FIGS. 1 to 4 relate to a first embodiment of the present invention, FIG. 1 is an appearance view showing a mobile information terminal apparatus;

FIG. 2 is a functional block diagram showing the basic structure of the mobile information terminal apparatus;

FIG. 3 is an explanatory diagram showing the structure of a calculating portion;

FIG. 4 is a functional block diagram showing the structure of an LCD portion with a scanner;

FIG. 5 is a functional block diagram corresponding to that shown in FIG. 2 according to a second embodiment of the present invention; and

FIG. 6 is a functional block diagram corresponding to that shown in FIG. 2 according to a third embodiment of the present invention.

### DETAILED DESCRIPTION OF THE PREFERRED EMBODIMENTS

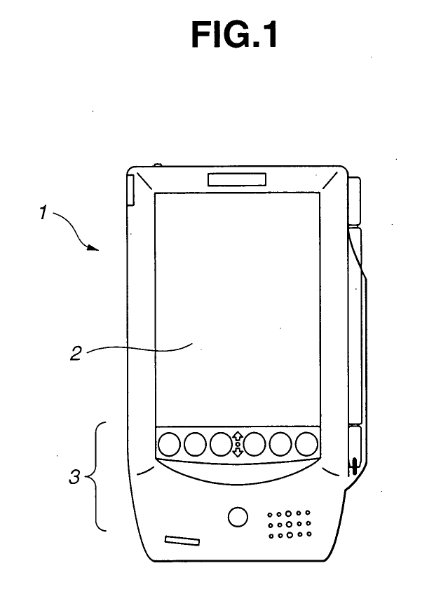

Hereinbelow, a description is given of an embodiment of the present invention with reference to the drawings. FIGS. 1 to 4 show the first embodiment of the present invention.

A mobile information terminal apparatus 1 shown in FIG. 1 is a mobile apparatus such as a PDA having an internal battery, and has the size for holding by user's one hand. The mobile information terminal apparatus 1 comprises in front thereof: an LCD portion 2 with a scanner as an information input/output portion; and an operation portion 3 on which a power switch, a key switch and the like are arranged to predetermined portions. The LCD portion 2 with the scanner shares ⅔ or more of the front portion, having the size for placing at least the entire business card.

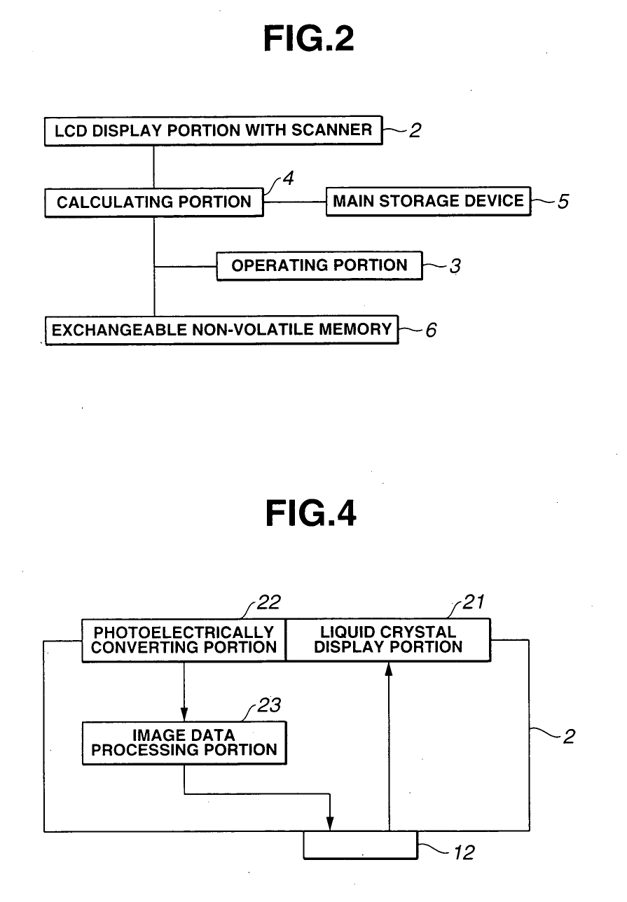

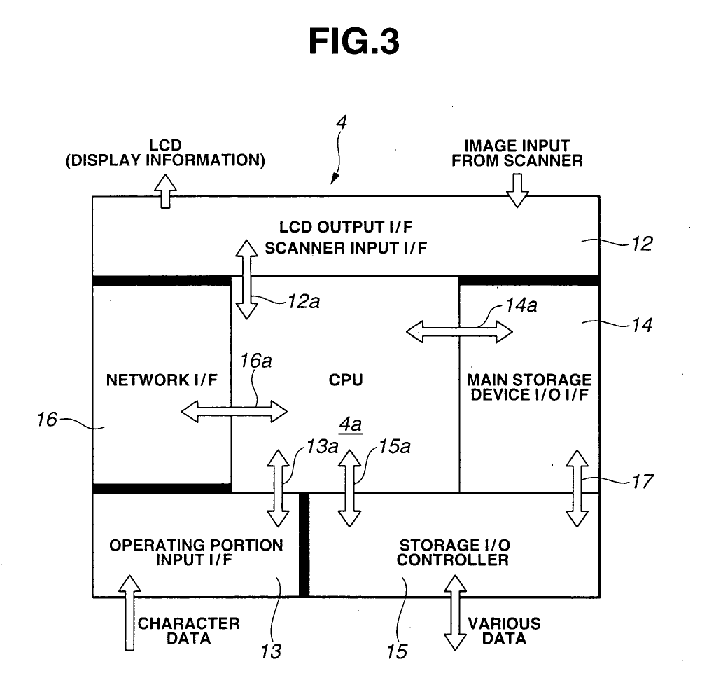

FIG. 2 shows the basic structure of the mobile information terminal apparatus 1. The mobile information terminal apparatus 1 has a calculating portion 4. Referring to FIG. 3, the calculating portion 4 mainly comprises a CPU 4a for entirely controlling the system.

Connected to the CPU 4a are an input/output (I/O) interface (I/F) 12 as an LCD output interface (I/F) and a scanner input interface (I/F), an operation portion input interface (I/F) 13, a main storage device input/output (I/O) interface (I/F) 14, a storage input/output (I/O) controller 15, and a network interface (I/F) 16 via bus lines 12a to 16a. Further, the main storage device input/output interface 14 and the storage input/output controller 15 are directly connected via a DMA (direct memory access) bus 17, thereby directly transferring the data not via the CPU 4a.

Referring to FIG. 2, connected to the interfaces 12 to 14 arranged to the calculating portion 4 are the LCD portion 2 with the scanner, the operating portion 3, a built-in main storage device 5 comprising a ROM for storing a program for controlling the system and a dictionary file and the like and a RAM for temporarily storing calculation data and the like. Further, detachably connected to the interfaces 12 to 14 is a non-volatile memory 6 as an exchangeable recording medium, such as an MD (mini disc) and an SD (secure digital) card. The mobile information terminal apparatus 1 according to the first embodiment shares the data and receives/sends the data to another protocol by the connection to a network line by radio or wiring via the network interface 16.

FIG. 4 shows the functional structure of the LCD portion 2 with the scanner. The LCD portion 2 with the scanner comprises: a liquid crystal display portion 21 as display means, a photoelectrically converting portion 22 as scanning means, and an image data processing portion 23.

The liquid crystal display portion 21 comprises a TFT (thin film transistor) liquid crystal panel having liquid crystal between two transparent substrates having a transparent electrode, and displays various information by a display driving signal from the CPU 4a.

The photoelectrically converting portion 22 comprises light receiving elements such as photo diodes, which are arranged like dots at a predetermined interval throughout the liquid crystal panel.

The image data processing portion 23 converts the information photoelectrically-converted by the light receiving elements into image data by binary processing and outputs the converted data to the calculating portion 4.

The CPU 4a writes and stores the captured image data to the non-volatile memory 6.

Next, a description is given of the operation of the mobile information terminal apparatus 1 with the above-mentioned structure according to the first embodiment.

An operator operates the key switch arranged to the operating portion 3 in the mobile information terminal apparatus 1 and inputs character data. Then, the character data is inputted to the CPU 4a via the operation portion input interface 13. The CPU 4a searches for the dictionary file stored in the ROM, and outputs and displays the corresponding character onto the LCD portion 2 with the scanner from the LCD output interface of the input/output interface 12.

Meanwhile, upon scanning the sheet medium such as the business card, the sheet medium to be scanned is set on the LCD portion 2 with the scanner. Next, the scanning operation starts by operating the key switch arranged to the operating portion 3. Then, the photoelectrically converting portion 22 comprising a multiplicity of the light receiving elements arranged to the LCD portion 2 with the scanner photoelectrically converts information described on the sheet medium, and the image data processing portion 23 converts the photoelectrically-converted data into image data by the binary processing and the like and outputs the converted data to the calculating portion 4.

The calculating portion 4 displays the inputted image data on the LCD portion 2 with the scanner. When it is necessary to recognize the image data of the displayed sheet medium and edit the data such as the addition of a comment, the operator edits the data by operating the key switch arranged to the operating portion 3. After that, upon registering the data, the operator inputs a file name and presses an executing key such as “ENTER” key arranged to the operating portion 3.

Then, the image data corresponding to the currently-read sheet medium is written and stored to the non-volatile memory 6. Upon storing the file in the non-volatile memory 6, the creating time and the final-processing time are automatically inputted.

In this case, when a character recognizing program is registered to the mobile information terminal apparatus 1, the image data is converted into the character, and the data is further converted into convenient digital data (text data or PDF (portable document format) data) and is stored.

The digital file recorded in the non-volatile memory 6 is classified and is managed depending on the registering portion, creating time, final-processing time, and comment or the like.

By the way, since the LCD portion 2 with the scanner is shielded by the sheet medium during scanning the sheet medium, it is not possible to obtain, from the LCD portion 2 with the scanner, information such as reading completing period or reading error. Therefore, according to the first embodiment, the mobile information terminal apparatus 1 comprises an LED, a speaker, a buzzer, and a vibration mechanism, thereby sending a notification indicating the reading completion and reading error to the operator at a flicker interval of the LED, the interval of voice generated from the speaker, the interval of buzzer sound, vibration operation, or the interval thereof.

According to the first embodiment, the LCD portion 2 with the scanner has the photoelectrically converting portion 22 having the function of the scanner which is formed by arranging many light-receiving elements. Thus, the number of parts is reduced, the size and weight of the mobile information terminal apparatus 1 are reduced, and the mobility is improved.

The non-volatile memory 6 is detachable and therefore it is replaced with a new non-volatile memory 6 with the simple operation when the non-volatile memory 6 runs out of capacity. Further, the data recorded to the non-volatile memory 6 is easily copied or is moved to another device such as a personal computer.

Further, a non-volatile memory 6 with a large capacity is attached and therefore even the image data having a relatively large capacity is easily stored without paying attention to the free capacity of the non-volatile memory 6, and operability is high. Furthermore, the reliability against attack and vibration is improved by using the non-volatile memory 6.

The medium as the scanning target of the LCD portion 2 with the scanner, is not limited to the sheet medium and it is certificated by using barcode or fingerprint. The medium of the LCD portion 2 with the scanner has a certificating function, thereby setting the security function by the mobile information terminal apparatus 1 alone.

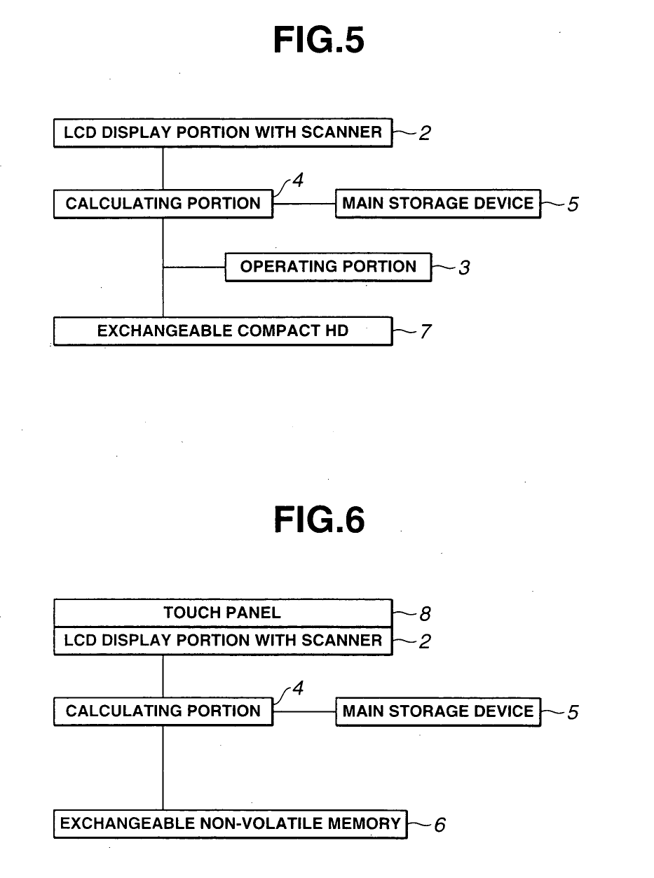

FIG. 5 shows a functional block diagram corresponding to that shown in FIG. 2 according to the second embodiment of the present invention. Although the non-volatile memory 6 is used as the exchangeable recording medium according to the first embodiment, a compact hard disk 7 is used as an exchangeable recording medium according to the second embodiment.

A larger recording capacity is ensured by using the compact hard disk 7 as the exchangeable recording medium.

The mobile information terminal apparatus can be used for a long time by providing a function for counting a non-operating time and a function for automatically switching the driving operation of the compact hard disk 7 to a power-saving mode when a predetermined time passes.

FIG. 6 is a functional block diagram corresponding to that shown in FIG. 2 according to the third embodiment of the present invention. Although the mobile information terminal apparatus 1 has the operating portion 3 according to the first embodiment, a touch panel 8 is arranged onto the LCD portion 2 with the scanner without arranging the operating portion 3.

On the touch panel 8, a character or the like displayed on the screen is touched by the finger or stylus pen or the like, thereby inputting data. The touch panel 8 is operated similarly to the operation of the key switch arranged to the operating portion 3.

When the mobile information terminal apparatus 1 according to the third embodiment has the same size as that of the mobile information terminal apparatus 1 according to the first embodiment, the display surface of the LCD portion 2 with the scanner is relatively large by using the touch panel 8 in place of the operating portion 3. When the display surface of the LCD portion 2 with the scanner is the same as that of the mobile information terminal apparatus 1 according to the first embodiment, the apparatus size is relatively small.

As mentioned above, according to the present invention, the entire mobile information terminal apparatus does not increase in size and the high mobility is obtained even when the apparatus has the display panel and the scanner. Further, when the storage capacity is insufficient, the operation is simple and is convenient without deleting the existing data.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

1. A mobile information terminal apparatus comprising:
display means which displays information;
scanning means which captures image information; and
a recording medium which records information,
wherein the scanning means is incorporated in the display means.

2. A mobile information terminal apparatus according to claim 1, wherein the scanning means comprises a plurality of light receiving elements which are arranged like dots to the display means.

3. A mobile information terminal apparatus according to claim 1, wherein the recording medium is an exchangeable non-volatile memory.

4. A mobile information terminal apparatus according to claim 1, wherein the recording medium is an exchangeable compact hard disk.

5. A mobile information terminal apparatus comprising:
display means which displays information;
scanning means which captures image information; and
a recording medium which records information,
wherein the scanning means is incorporated in the display means and the display means has a touch panel.

6. A mobile information terminal apparatus according to claim 5, wherein the scanning means comprises a plurality of light receiving elements which are arranged like dots to the display means.

7. A mobile information terminal apparatus according to claim 5, wherein the recording medium is an exchangeable non-volatile memory.

8. A mobile information terminal apparatus according to claim 5, wherein the recording medium is an exchangeable compact hard disk.
